(19) United States
(12) Patent Application Publication
(10) Pub. No.: US 2009/0073281 A1
(43) Pub. Date: Mar. 19, 2009

(54) IMAGE SENSOR

(75) Inventor: Toshikazu OHNO, Mizuho-shi (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/039,012

(22) Filed: Feb. 28, 2008

(30) Foreign Application Priority Data
Feb. 28, 2007 (JP) JP2007-48680

(51) Int. Cl. H04N 9/73

(52) U.S. Cl. 348/223.1; 348/E09.051

(57) ABSTRACT

An image sensor includes a plurality of pixels having a plurality of color sensitivity characteristics and a mixing portion for mixing charges stored in a plurality of the pixels having the same color sensitivity characteristic provided adjacent to a plurality of the pixels having the same color sensitivity characteristic.

### CROSS-REFERENCE TO RELATED APPLICATIONS

The priority application number JP2007-048680, Image Sensor, Feb. 28, 2007, Toshikazu Ohno, upon which this patent application is based is hereby incorporated by reference.

### BACKGROUND OF THE INVENTION

1. Field of the Invention

The present invention relates to an image sensor, and more particularly, it relates to an image sensor in which charges stored in pixels are mixed.

2. Description of the Background Art

An image sensor in which charges stored in pixels are mixed is known in general.

There is disclosed an image sensor comprising a plurality of pixels arranged in the form of a matrix, a vertical shift register vertically transferring information charges generated in the pixels, and a horizontal shift register horizontally transferring the information charges transferred from the vertical shift register, wherein the information charges are read from the pixels and thereafter the information charges of each three pixels are added and composited in the horizontal transfer direction. In this conventional image sensor, the information charges of each three pixels are added and composited and hence photosensitivity of the image sensor is improved and transfer time of the information charges can be reduced.

There is disclosed an image sensor comprising a plurality of pixels arranged in the form of a matrix, a vertical shift register vertically transferring information charges generated in the pixels, and a horizontal shift register horizontally transferring the information charges transferred from the vertical shift register, wherein the information charges are read from the pixels and thereafter the information charges corresponding to the central pixel among the information charges of each consecutive three pixels are ejected on the way to the vertical transfer and the information charges of each remaining two pixels are added and composited in the vertical transfer direction.

### SUMMARY OF THE INVENTION

An image sensor according to an aspect of the present invention comprises a plurality of pixels having a plurality of color sensitivity characteristics, and a mixing portion for mixing charges stored in a plurality of the pixels having the same color sensitivity characteristic, provided adjacent to a plurality of the pixels having the same color sensitivity characteristic.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an arrangement diagram of pixels arranged on an image region of an image sensor according to a first embodiment of the present invention;

FIG. 2 is a surface view of the image region according to the first embodiment of the present invention;

FIG. 3 illustrates a state of mixture of charges stored in each three pixels having the same color sensitivity characteristic adjacent to each other in an L-shape according to the first embodiment of the present invention;

FIG. 4 illustrates pixels where charges are mixed in response to object information according to a second embodiment of the present invention;

FIG. 5 illustrates object information by region in a screen according to a third embodiment of the present invention;

FIG. 6 illustrates pixels multiplied by region in a screen according to the third embodiment of the present invention;

FIG. 7 is an arrangement diagram of pixels and mixing regions arranged on an image region of an image sensor according to a fourth embodiment of the present invention;

FIG. 8 is a surface view of the image region according to the fourth embodiment of the present invention; and

FIG. 9 illustrates a state where charges stored in each four pixels having the same color sensitivity characteristic adjacent to each other according to the fourth embodiment of the present invention are mixed in the mixing region.

### DESCRIPTION OF THE PREFERRED EMBODIMENTS

Embodiments of the present invention will be hereinafter described with reference to the drawings.

### First Embodiment

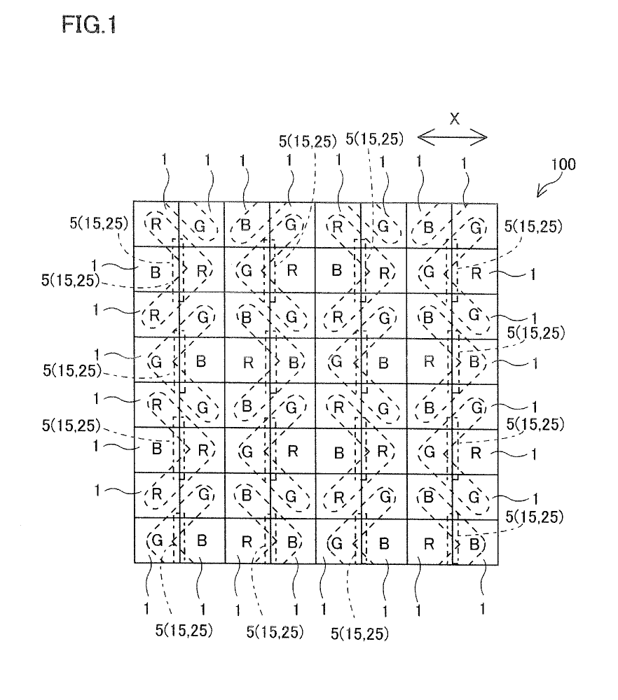

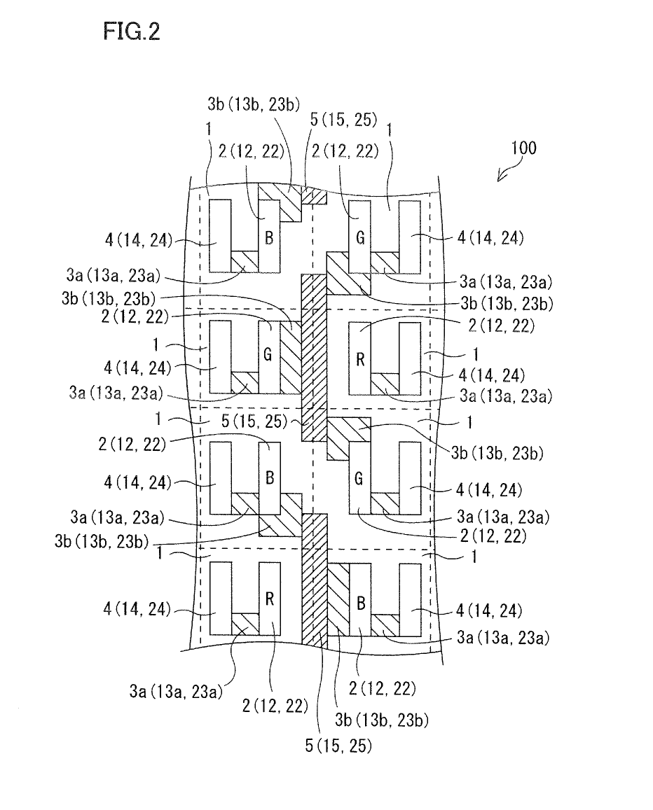

A structure of an image region 100 of an image sensor according to a first embodiment will be described with reference to FIGS. 1 and 2.

In the image region 100 of the image sensor according to the first embodiment, pixels 1 having different color sensitivity characteristics, i.e., red (R), green (G) and blue (B) color sensitivity characteristics are arranged in the form of a matrix, as shown in FIG. 1. The pixels 1 having the different color sensitivity characteristics, i.e., the red (R), green (G) and blue (B) color sensitivity characteristics are arranged such that the pixels 1 having the same color sensitivity characteristic are adjacent to each other in an oblique direction in plan view. According to the first embodiment, the pixels 1 having the same color sensitivity characteristic adjacent to each other in the oblique direction are arranged such that the three pixels 1 having the same color sensitivity characteristic are adjacent to each other in an L-shape surrounded by a dotted line in FIG. 1. Some pixels 1 are not adjacent to the pixels 1 having the same color sensitivity characteristic in the oblique direction or are not arranged such that the three pixels 1 are adjacent in the L-shape although the two pixels 1 having the same color sensitivity characteristic are adjacent to each other in the oblique direction, as the pixels 1 not surrounded by the dotted line in FIG. 1.

Rows in which groups of three pixels 1 having the same color sensitivity characteristic adjacent to each other in the L-shape are aligned in a row direction (direction X in FIG. 1) in the order of red (R), green (G), red (R), green (G) and rows in which groups of three pixels 1 having the same color sensitivity characteristic adjacent to each other in the L-shape are aligned in the row direction in the order of green (G), blue (B), green (G), blue (B) are alternately arranged.

As shown in FIG. 2, each of the pixels 1 comprises a photodiode 2, switch gate electrodes 3a and 3b and a read portion 4. Each switch gate electrode 3a is arranged between the photodiode 2 and the read portion 4. The switch gate electrodes 3a and 3b are examples of the “first switch gate electrode” and the “second switch gate electrode” in the present invention respectively. According to the first embodiment, multiplication gate electrodes 5 each having a function of mixing charges stored in a plurality of the pixels 1 and multiplying the same are provided between the switch gate electrodes 3b of the three pixels 1 having the same color sensitivity characteristic adjacent to each other in the L-shape shown by the dotted line in FIG. 1. The multiplication gate electrodes 5 are examples of the “mixing portions” in the present invention. The multiplication gate electrodes 5 multiply electrons due to an electron avalanche phenomenon caused by applying a high voltage to the multiplication gate electrodes 5, for example.

An operation of the image sensor according to the first embodiment of the present invention will be now described with reference to FIGS. 1 to 3.

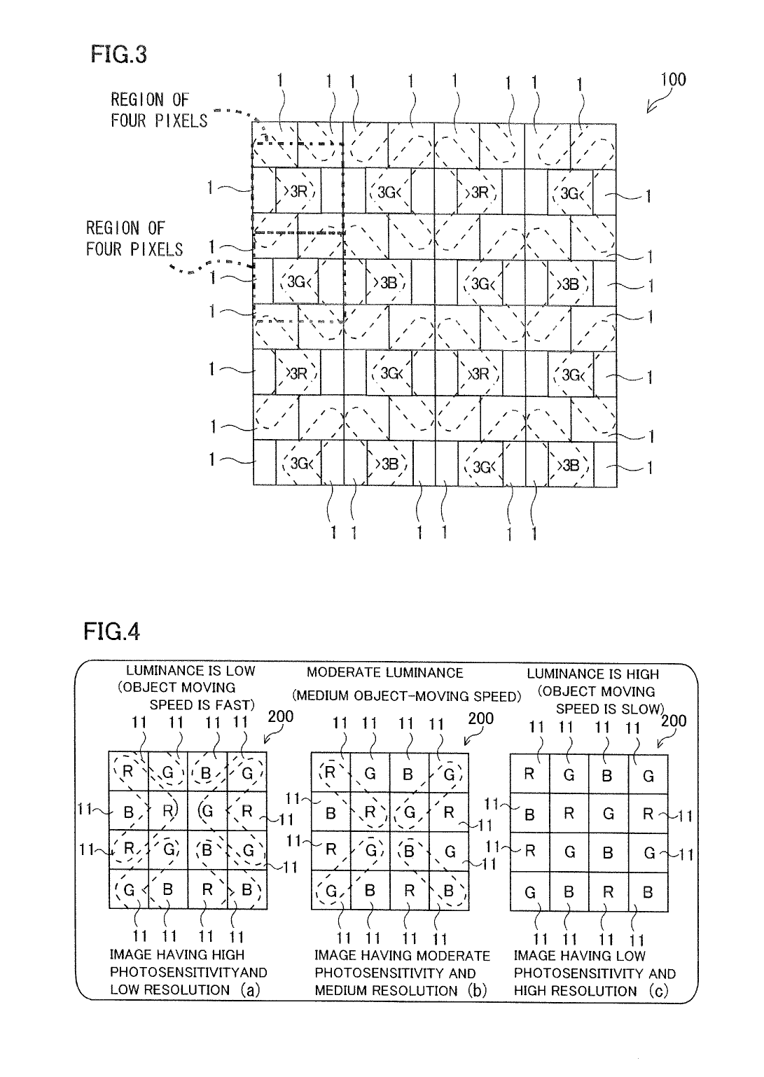

Charges stored in the photodiodes 2 (see FIG. 2) of the three pixels 1 having the same color sensitivity characteristic adjacent to each other in the L-shape as shown in FIG. 1 are collected under each multiplication gate electrode 5 (see FIG. 2) through the switch gate electrodes 3b (see FIG. 2) so that charges stored in the three pixels 1 are mixed as shown in FIG. 3. In FIG. 3, a symbol 3R represents that charges stored in the three pixels 1 having the red (R) color sensitivity characteristic have been mixed, a symbol 3G represents that charges stored in the three pixels 1 having the green (G) color sensitivity characteristic have been mixed and a symbol 3B represents that charges stored in the three pixels 1 having the blue (B) color sensitivity characteristic have been mixed. Charges stored in each three pixels 1 are mixed with respect to a region of the four pixels 1 shown by an alternate long and short dash line in FIG. 3.

As shown in FIG. 3, the arrangement of the mixed charges is a Bayer arrangement, that is, the row where the red (R) and the green (G) alternately appear and the row where the green (G) and the blue (B) alternately appear alternately appear.

A high voltage allowing multiplication of charges is applied to the multiplication gate electrodes 5, thereby multiplying the number of charges stored under the multiplication gate electrodes 5. Thus, long exposure time is not required for earning sufficient photosensitivity (quantity of charges) even when the amount of light is not stuffiest, and hence wobbling of an object in taking an image of the object moving at a high speed can be suppressed. Thereafter multiplied charges are read, thereby obtaining an image. When the amount of light is sufficient, charges are neither mixed nor multiplied and neither mixed nor multiplied charges stored in the pixels 1 are read.

Alternatively, both of the charges mixed and multiplied and the neither mixed nor multiplied charges may be read.

According to the first embodiment, as hereinabove described, the multiplication gate electrodes 5 for mixing the charges stored in the plurality of pixels 1 having the same color sensitivity characteristic are provided in the vicinity of the plurality of pixels 1 having the same color sensitivity characteristic, whereby the charges stored in the pixels 1 can be mixed in the vicinity of the plurality of pixels 1 having the same color sensitivity characteristic and hence the mixed charges can be read. Thus, photosensitivity of the image sensor can be improved, and noise generated when reading the charges can be reduced since the number of the read of the charges is reduced as compared with a case where the charges are mixed after reading the charges stored in the pixels 1.

According to the first embodiment, as hereinabove described, the mixed and multiplied charges stored in the pixels 1 are read when the amount of light is not sufficient, whereby an image having high photosensitivity can be obtained When the amount of light is sufficient, charges are neither mixed nor multiplied and the neither mixed nor multiplied charges stored in the pixels 1 are read, whereby an image having high resolution can be obtained.

According to the first embodiment, as hereinabove described, the pixels 1 where the stored charges are mixed between the plurality of pixels 1 and the pixels 1 where the stored charges are not mixed mixedly exist, and both of the mixed and multiplied charges and the neither mixed nor multiplied charges are read. Thus, in the pixels 1 where the multiplied charges are saturated in a screen, an image on the saturated screen can be reproduced by estimating a quantity of the saturated charges stored in the pixel from a quantity of the neither mixed nor multiplied charges stored in the pixels 1. Consequently, a dynamic range of the image sensor can be enlarged.

According to the first embodiment, as hereinabove described, the multiplication gate electrodes 5 are arranged between the pixels 1 adjacent to each other, whereby the multiplication gate electrodes 5 can be minimized as compared with a case where the charges stored in pixels 1 not adjacent to each other and multiplied.

According to the first embodiment, as hereinabove described, the arrangement of the mixed charges is the Bayer arrangement, that is, the row where the red (R) and the green (G) alternately appear and the row where the green (G) and the blue (B) alternately appear alternately appear. Thus, color reproduction is excellent and a color image having high photosensitivity can be obtained.

According to the first embodiment, as hereinabove described, the plurality of pixels 1 having the same color sensitivity characteristic, where charges stored in the pixels 1 are mixed, are arranged adjacent to each other in the oblique direction in plan view, whereby the pixels 1 having the same color sensitivity characteristic, where charges are mixed, are arranged adjacent to each other dissimilarly to the Bayer arrangement in which pixels 1 having the red (R) color sensitivity characteristic are arranged with the pixels having the green (G) color sensitivity characteristic therebetween and pixels having the blue (B) color sensitivity characteristic are arranged with the pixels having the green (G) color sensitivity characteristic therebetween among the red (R), the blue (B) and the green (G) color sensitivity characteristics, and hence the charges can be mixed in a narrow range. Thus, the arrangement of the charges after mixture can be thicker than the Bayer arrangement and hence resolution of the image sensor can be enhanced.

According to the first embodiment, as hereinabove described, the switch gate electrodes 3a are provided between the photodiodes 2 and the read portions 4, and the switch gate electrodes 3b are provided between the photodiodes 2 and the multiplication gate electrodes 5, whereby charges can be easily transferred under the multiplication gate electrodes 5 from the photodiodes 2 with the switch gate electrode 3a and the switch gate electrode 3b.

According to the first embodiment, as hereinabove described, the multiplication gate electrodes 5 have a function of mixing the stored charges and multiplying the same, whereby photosensitivity of the image sensor can be greatly enhanced without deteriorating resolution of the image sensor as compared with a case of only mixing the charges.

### Second Embodiment

In a second embodiment, a structure of an image region 200 of an image sensor in which the number of pixels 11 where charges are mixed is switched in response to object information will be described with reference to FIGS. 2 and 4, dissimilarly to the aforementioned first embodiment.

In the image region 200 of the image sensor according to the second embodiment, pixels 11 having different color sensitivity characteristics, i.e., red (R), green (G) and blue (B) color sensitivity characteristics are arranged such that the pixels 11 having the same color sensitivity characteristic are adjacent to each other in an oblique direction as shown in FIGS. 4(a) to 4(c), similarly to the first embodiment. Photodiodes 12, switch gate electrodes 13a and 13b a read portions 14 and multiplication gate electrodes 15 in the pixels 11 according to the second embodiment are similar to those of the first embodiment shown in FIG. 2. The multiplication gate electrodes 15 are examples of the “mixing portions” in the present invention. According to the second embodiment, the pixels 11 where charges are mixed and multiplied can be selected by an ON/OFF operation of the switch gate electrodes 13b shown in FIG. 2.

An operation of the image sensor according to the second embodiment of the present invention will be now described with reference to FIG. 4.

As shown in FIG. 4(a), when the luminance of an object is low, charges stored in three pixels 11 having the same color sensitivity characteristic, arranged in an L-shape surrounded by a dotted line are mixed and multiplied, whereby an image having high photosensitivity and low resolution can be obtained. As shown in FIG. 4(b), when the luminance of the object is moderate, charges stored in two pixels 11 having the same color sensitivity characteristic adjacent to each other in the oblique direction surrounded by a dotted line are mixed and multiplied, whereby an image having moderate photosensitivity and medium resolution can be obtained. As shown in FIG. 4(c), when the luminance of the object is high, charges stored in the pixels 11 are neither mixed nor multiplied, and charges of all the pixels 11 are read. Thus, an image having low photosensitivity and high resolution can be obtained.

As shown in FIG. 4(a), when the object moving speed of the object is fast, the charges stored in the three pixels 11 having the same color sensitivity characteristic arranged in the L-shape are mixed and multiplied, whereby the image having high photosensitivity and low resolution can be obtained. The high photosensitive pixels 11 can reduce exposure time, whereby an image of an object moving at a high speed can be taken. As shown in FIG. 4(b), when the object moving speed is moderate, the charges stored in the two pixels 11 having the same color sensitivity characteristic adjacent to each other in the oblique direction are mixed and multiplied, whereby the image having moderate photosensitivity and medium resolution can be obtained. As shown in FIG. 4(c), when the object moving speed is slow, the charges stored in the pixels 11 are neither mixed nor multiplied, and the charges of all the pixels 11 are read. Thus, the image having low photosensitivity and high resolution can be obtained.

According to the second embodiment, as hereinabove described, the number of the pixels 11 where the charges are mixed is switched in response to the object information, whereby an optimum image according to the object information such as the luminance or the object moving speed can be easily obtained.

The remaining effects of the second embodiment are similar to those of the aforementioned first embodiment.

### Third Embodiment

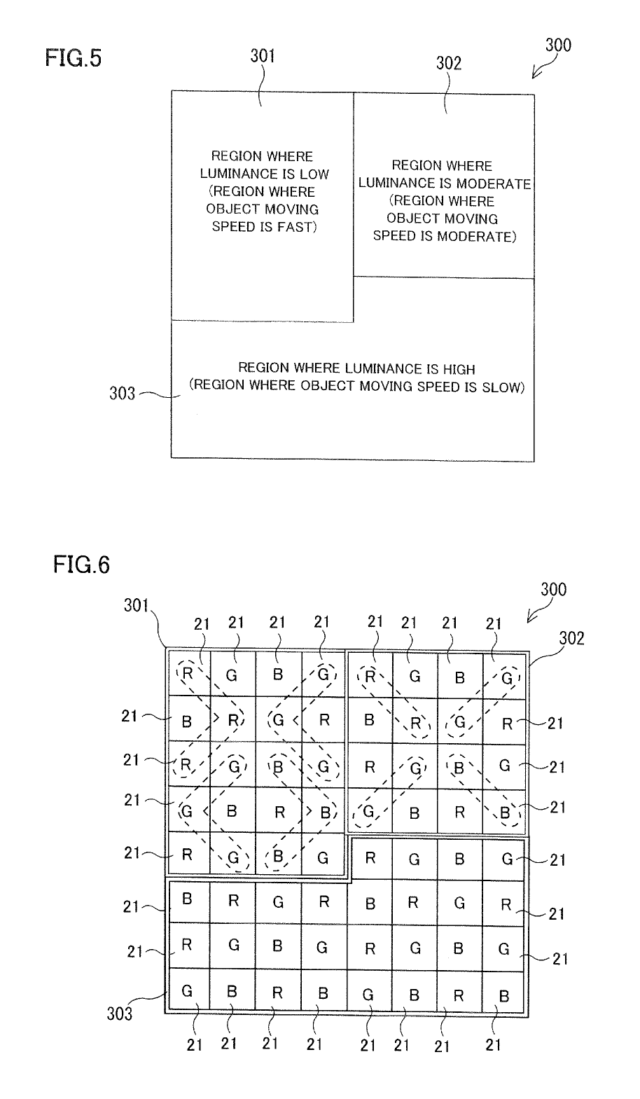

In a third embodiment, a structure of an image region 300 of an image sensor in which the number of pixels 11 where charges are multiplied is vary by region in a screen will be described with reference to FIGS. 5 and 6, dissimilarly to the aforementioned first embodiment.

The image region 300 of the image sensor according to the third embodiment is formed such that the number of pixels 21 (see FIG. 6) where the charges are multiplied is vary by region in the screen when object information varies with the regions in the screen, as shown in FIG. 5. Photodiodes 22, switch gate electrodes 23a and 23b a read portions 24 and multiplication gate electrodes 25 in the pixels 21 according to the third embodiment are similar to those of the first embodiment shown in FIG. 2. The multiplication gate electrodes 25 are examples of the “mixing portions” in the present invention. According to the third embodiment, the pixels 21 where the charges are mixed and multiplied can be selected by an ON/OFF operation of the switch gate electrodes 23b shown in FIG. 2, similarly to the second embodiment.

An operation of the image sensor according to the third embodiment of the present invention will be now described with reference to FIGS. 5 and 6.

As shown in FIG. 6, in a region 301 where the luminance of an object is low, shown in FIG. 5, charges stored in three pixels 21 having the same color sensitivity characteristic, arranged in an L-shape surrounded by a dotted line are mixed and multiplied, whereby an image having high photosensitivity and low resolution can be obtained. In a region 302 where the luminance of the object is moderate, charges stored in two pixels 21 having the same color sensitivity characteristic adjacent to each other in the oblique direction surrounded by a dotted line are mixed and multiplied, whereby an image having moderate photosensitivity and medium resolution can be obtained. In a region 303 where the luminance of the object is high, charges stored in the pixels 21 are neither mixed nor multiplied, and charges of all the pixels 21 are read. Thus, an image having low photosensitivity and high resolution can be obtained. Consequently, an image having a wide range of luminance from the region 301 where the luminance is low and to the region 303 where the luminance is high can be obtained in one screen, and hence a dynamic range of the image sensor can be enlarged.

As shown in FIG. 6, in the region 301 where the object moving speed of the object is fast shown, in FIG. 5, the charges stored in the three pixels 21 having the same color sensitivity characteristic arranged in the L-shape are mixed and multiplied, whereby the image having high photosensitivity and low resolution can be obtained. The high photosensitive pixels 21 can reduce exposure time, whereby an image of an object moving at a high speed can be taken. In the region 302 where the object moving speed is moderate, the charges stored in the two pixels 21 having the same color sensitivity characteristic adjacent to each other in the oblique direction surrounded by the dotted line are mixed and multiplied, whereby the image having moderate photosensitivity and medium resolution can be obtained. In the region 303 where the object moving speed is slow, the charges stored in the pixels 21 are neither mixed nor multiplied, and the charges of all the pixels 21 are read. Thus, the image having low photosensitivity and high resolution can be obtained.

According to the third embodiment, as hereinabove described, the image sensor is so formed as to have the region where the charges in the three pixels 21 are mixed, multiplied and read, the region where the charges in the two pixels 21 among the three pixels 21 are mixed, multiplied and read, and the region where the charges in all the pixels 21 are read without multiplication, whereby an optimum image according to the object information such as the luminance or the object moving speed can be easily obtained.

The remaining effects of the third embodiment are similar to those of the aforementioned first embodiment.

### Fourth Embodiment

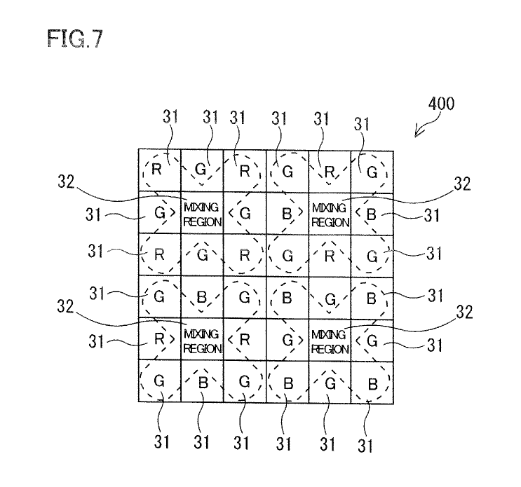

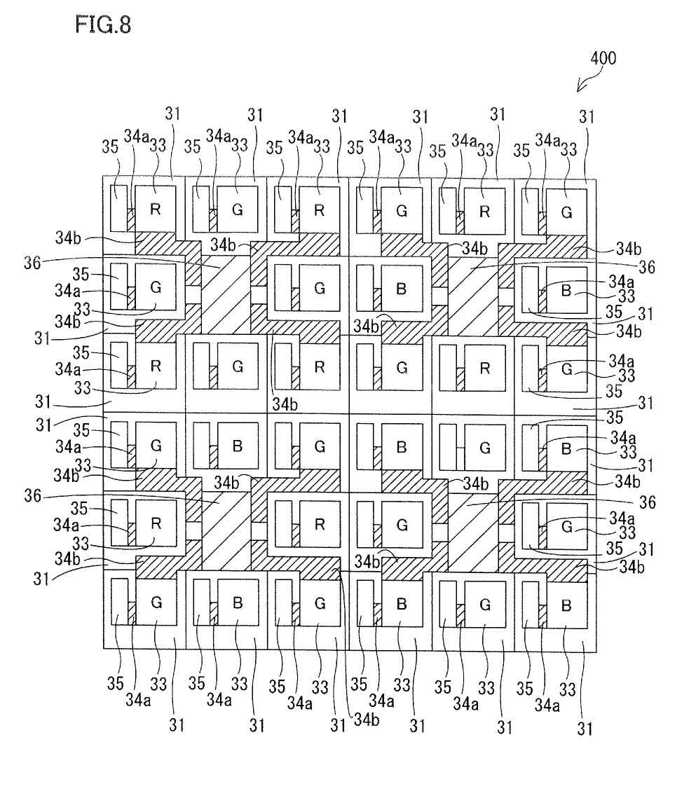

In a fourth embodiment, a structure of an image region 400 of an image sensor in which charges stored in each four pixels 31 having the same color sensitivity characteristic are mixed in a mixing region 32 will be described with reference to FIGS. 7 and 8, dissimilarly to the aforementioned first embodiment.

In the image region 400 of the image sensor according to the fourth embodiment, the central pixel 31 among each nine pixels 31 of height 3 pixels×width 3 pixels in a Bayer arrangement is placed by the mixing region 32 as shown in FIG. 7. In this arrangement, the four pixels 31 adjacent to each mixing region 32 in an oblique direction have the same color sensitivity characteristic.

As shown in FIG. 8, the pixels 31 where the stored charges are mixed are provided with photodiodes 33, switch gate electrodes 34a and 34b and read portions 35. Multiplication gate electrodes 36 are provided on the mixing regions 32 (see FIG. 7). The multiplication gate electrodes 36 are examples of the “mixing portions” in the present invention. Each multiplication gate electrode 36 is arranged adjacent to the switch gate electrodes 34b provided in the four pixels 31 having the same color sensitivity characteristic. The switch gate electrodes 34b are not provided on the pixels 31 where the stored charges are not mixed.

An operation of the image sensor according to the third embodiment of the present invention will be now described with reference to FIGS. 7 to 9.

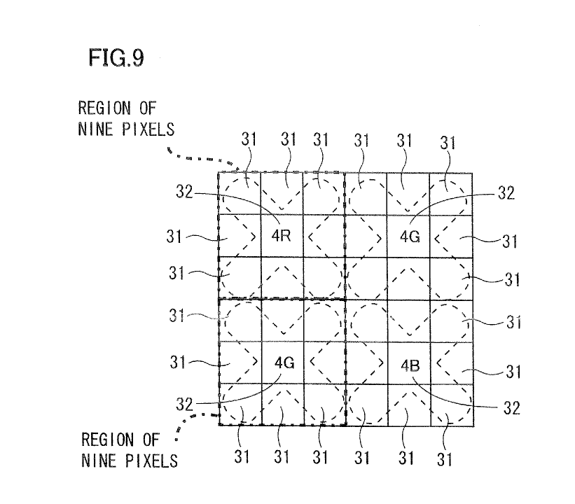

Charges stored in the photodiodes 33 of the four pixels 31 (see FIG. 7) having the same color sensitivity characteristic shown in FIG. 8 are collected under each multiplication gate electrode 36 of the mixing region 32 (see FIG. 7) through the switch gate electrodes 34b. Thus, charges stored in the four pixels 31 surrounded by a dotted line are mixed as shown in FIG. 9. In FIG. 9, a symbol 4R represents that charges stored in the four pixels 31 having the red (R) color sensitivity characteristic have been mixed, a symbol 4G represents that charges stored in the four pixels 31 having the green (G) color sensitivity characteristic have been mixed and a symbol 4B represents that charges stored in the four pixels 31 having the blue (B) color sensitivity characteristic have been mixed. Charges stored in each four pixels 1 are mixed with respect to a region of the nine pixels 31 including the mixing region 32 shown by an alternate long and short dash line in FIG. 9.

As shown in FIG. 9, the arrangement of the mixed charges is a Bayer arrangement, that is, the row where the red (R) and the green (G) alternately appear and the row where the green (G) and the blue (B) alternately appear alternately appear. Thus, color reproduction is excellent and a color image having high photosensitivity can be obtained.

A high voltage allowing multiplication of charges is applied to the multiplication gate electrodes 36 (see FIG. 8), thereby multiplying the number of charges stored under the multiplication gate electrodes 36. Thus, long exposure time is not required for earning sufficient photosensitivity (quantity of charges) even when the amount of light is not stuffiest, and hence wobbling of an object in taking an image of the object moving at a high speed can be suppressed. Thereafter the multiplied charges are read, thereby obtaining an image. When the amount of light is sufficient, charges are neither mixed nor multiplied and the neither mixed nor multiplied charges stored in the pixels 31 are read. In this case, the mixing regions 32 are provided, whereby the Bayer arrangement can be formed by estimating a quantity of the charges stored in the mixing regions 32 from a quantity of the charges stored in pixels 31 around the mixing regions 32 although information of one pixel 31 among each nine pixels 31 is lacking.

Alternatively, both of the charges multiplied and the charges not multiplied may be read. Thus, in the pixels 31 where the multiplied charges are saturated in a screen, an image on the saturated screen can be reproduced by estimating a quantity of the saturated charges stored in the pixel 31 by employing a quantity of the charges not multiplied, stored in pixels 31. Consequently, a dynamic range of the image sensor can be enlarged.

The resolution of the image sensor according to the fourth embodiment is lower than that of the image sensor according to the first embodiment since the mixing regions 32 are provided. According to the forth embodiment, however, the arrangement of the red (R), the green (G) and the blue (B) employed as the color sensitivity characteristics of the pixels 31 in a case of mixing and multiplying the charges is the same as that in a case of neither mixing nor multiplying the charges and hence signal processing after reading the charges stored in the pixels 31 can be easily performed as compared with the case in the first embodiment.

According to the fourth embodiment, as hereinabove described, the mixing regions 32 separately provided from the pixels 31 are provided on regions surrounded by the plurality of pixels 31 where the stored charges are mixed, whereby the multiplication gate electrodes 36 can be easily arranged.

According to the fourth embodiment, as hereinabove described, each mixing region 32 is provided on the region of the central pixel in pixels 31 arranged in a three-row, three-column square, whereby the mixing regions 32 can be easily arranged in the form of a matrix.

According to the fourth embodiment, as hereinabove described, the arrangement of the mixing regions 32 is the Bayer arrangement, whereby the color reproduction is excellent and a color image having high photosensitivity can be obtained.

The remaining effects of the fourth embodiment are similar to those of the aforementioned first embodiment The number of pixels 31 where charges are mixed and multiplied is switched according to object information such as luminance or object moving speed or the region of the image region 400, whereby effects similar to those of the second and third embodiments can be obtained.

Although the present invention has been described and illustrated in detail, it is clearly understood that the same is by way of illustration and example only and is not to be taken by way of limitation, the spirit and scope of the present invention being limited only by the terms of the appended claims.

For example, while the multiplication gate electrodes each have a function of mixing the charges stored in the pixels and multiplying the same in each of the aforementioned first to fourth embodiments, the present invention is not restricted to this but the multiplication gate electrodes may be replaced by mixing gate electrode having no multiplication function. In this case, photosensitivity is not drastically improved as compared with a case of having a multiplication function, but effects similar to the aforementioned first to fourth embodiments other than the drastic improvement of the photosensitivity can be obtained.

What is claimed is:

1. An image sensor comprising:
a plurality of pixels having a plurality of color sensitivity characteristics, and
a mixing portion for mixing charges stored in a plurality of said pixels having the same color sensitivity characteristic, provided adjacent to a plurality of said pixels having the same color sensitivity characteristic.

2. The image sensor according to claim 1, wherein
said plurality of pixels having the same color sensitivity characteristic, where the charges stored in the pixels are mixed are arranged adjacent to each other in an oblique direction in plan view.

3. The image sensor according to claim 1, wherein
the number of said pixels where the charges are mixed in response to information of an object to be imaged is switched.

4. The image sensor according to claim 1, wherein
a case in which the charges stored in the pixels where the charges stored in said plurality of pixels are read and a case where the charges stored all of the pixels are read without mixture of the charges are switched in response to luminance of an object.

5. The image sensor according to claim 1, wherein
said plurality of pixels mixedly include the pixels where the charges stored in said plurality of pixels are mixed and the pixels where the stored charges are not mixed.

6. The image sensor according to claim 5, wherein
both of the charges stored in said pixels where the charges stored in said plurality of pixels are mixed and the charges stored in the pixels where the stored charges are not mixed are read.

7. The image sensor according to claim 1, wherein
said plurality of pixels having the same color sensitivity characteristic, where the charges stored in the pixels are mixed are constituted by the three pixels.

8. The image sensor according to claim 7, wherein
said three pixels having the same color sensitivity characteristic, where the charges stored in the pixels are mixed are adjacent to each other in an L-shape in plan view.

9. The image sensor according to claim 7, wherein
said mixing portion is so arranged as to be connected to said three pixels.

10 The image sensor according to claim 7, wherein
a plurality of said mixing portions are provided, and
said plurality of mixing portions are arranged in the form of a matrix in plan view.

11. The image sensor according to claim 7, wherein
a plurality of said mixing portions are provided,
said plurality of color sensitivity characteristics are composed of red, green and blue sensitivity characteristics, and
arrangement of the color sensitivity characteristics of the charges stored in said mixing portions, after being mixed by said mixing portions is a Bayer arrangement in which rows where the charges having the red and green color sensitivity characteristics are alternately arranged in a row direction and rows where the charges having the green and blue color sensitivity characteristics are alternately arranged in the row direction are alternately arranged.

12. The image sensor according to claim 7, wherein
a case in which the charges stored in said three pixels are mixed and read, a case in which the charges stored in the two pixels among said three pixels are mixed and read and a case in which the charges stored in all the pixels are read without mixture of the charges are switched in response to luminance of an object.

13. The image sensor according to claim 7, wherein
a case in which the charges stored in said three pixels are mixed and read, a case in which the charges stored in the two pixels among said three pixels are mixed and read and a case in which the charges stored in all the pixels are read without mixture of the charges are switched in response to object moving speed.

14. The image sensor according to claim 7, wherein
a region where the charges stored in said three pixels are mixed and read, a region where the charges stored in the two pixels among said three pixels are mixed and read and a region where the charges stored in all the pixels are read without mixture of the charges are provided in response to luminance of an object.

15. The image sensor according to claim 7, wherein
a region where the charges stored in said three pixels are mixed and read, a region where the charges stored in the two pixels among said three pixels are mixed and read and a region where the charges stored in all the pixels are read without mixture of the charges are provided in response to object moving speed.

16. The image sensor according to claim 1, wherein
each of said pixels includes a photodiode and a read portion reading the charges stored in said photodiode, and
a first switch gate electrode is provided between said photodiode and said read portion and a second switch gate electrode is provided between said photodiode and said mixing portion.

17. The image sensor according to claim 1, further comprising a mixing region provided separately from said pixels on a region surrounded by a plurality of said pixels where the stored charges are mixed.

18. The image sensor according to claim 17, wherein
said mixing region is provided on a region of a central pixel in the pixels arranged in a three-row, three-column square.

19. The image sensor according to claim 18, wherein
the four pixels adjacent to said mixing region in an oblique direction among said pixels arranged in said three-row, three-column square have the same color sensitivity characteristic.

20. The image sensor according to claim 18, wherein
a plurality of said mixing regions are provided,
said plurality of color sensitivity characteristics are composed of red, green and blue color sensitivity characteristics, and
arrangement of said mixing region is a Bayer arrangement in which rows where the mixing region mixing the charges stored in the pixels having said red color sensitivity characteristic and the mixing region mixing the charges stored in the pixels having said green color sensitivity characteristic are alternately arranged and rows where the mixing region mixing the charges stored in the pixels having said green color sensitivity characteristic and the mixing region mixing the charges stored in the pixels having said blue color sensitivity characteristic are alternately arranged are alternately arranged.

21. The image sensor according to claim 1, wherein
said mixing portion has a function of multiplying the charges.
